(19) United States
(12) Patent Application Publication
(10) Pub. No.: US 2013/0334342 A1
(43) Pub. Date: Dec. 19, 2013

(54) LIQUID ATOMIZING DEVICE AND LIQUID ATOMIZING METHOD

(71) Applicants: Hiroyoshi Asakawa, Hyogo (JP); Ryota Kuge, Hyogo (JP)

(72) Inventors: Hiroyoshi Asakawa, Hyogo (JP); Ryota Kuge, Hyogo (JP)

(73) Assignee: NOZZLE NETWORK CO., LTD., Tamba-shi, Hyogo (JP)

(21) Appl. No.: 14/002,086

(22) PCT Filed: Mar. 21, 2012
(86) PCT No.: PCT/JP2012/057171

§ 371 Date: Aug. 28, 2013

(30) Foreign Application Priority Data
Apr. 4, 2011 (JP) 2011-082905
Nov. 2, 2011 (JP) 2011-241322

(51) Int. Cl. B05B 7/02

(52) U.S. Cl. CPC B05B 7/025
USPC 239/422

(57) ABSTRACT

A liquid atomizing device includes a first gas injection portion and a second gas injection portion for making two gas flows collide against each other; a liquid outflow portion from which liquid flows out; a gas-liquid mixing area portion where a gas flow injected from the first gas injection portion, a gas flow injected from the second gas injection portion and liquid which flows out from the liquid outflow portion are made to collide against each other to atomize the liquid; an injection outlet portion in which the gas-liquid mixing area portion is formed; and a slit portion formed in a tip end surface of the injection outlet portion along a direction in which the mist is injected widely.

### TECHNICAL FIELD

The present invention relates to a liquid atomizing device and a liquid atomizing method for atomizing liquid.

### BACKGROUND ART

As conventional atomizing technique, there are a gas-liquid mix type (two-fluid type) technique, an ultrasound type technique, an extra-high voltage type (100 MPa to 300 MPa) technique, and a steaming type technique. According to a general two-fluid nozzle, gas and liquid are injected in the same injection direction, and liquid is miniaturized by a shear effect generated by accompanying flow of gas and liquid.

As one example of a gas-liquid mix type two-fluid nozzle, an atomizing nozzle device for producing minute particle mist is known (patent document 1). This atomizing nozzle device includes a first nozzle portion and a second nozzle portion, atomized liquid from the first nozzle portion and atomized liquid from the second nozzle portion are made to collide with each other, and minute particle mist can be formed. However, since the atomizing nozzle device includes two two-fluid nozzle portions, the atomizing nozzle device becomes expensive and this is not suitable for miniaturization.

### PRIOR ART DOCUMENTS

### Patent Documents

Patent Document 1: JP-A-2002-126587

### SUMMARY OF THE INVENTION

### Problems to be Solved by the Invention

It is an object of the present invention to provide a liquid atomizing device and a liquid atomizing method capable of atomizing liquid with a simple device configuration using a new principle which is different from the miniaturization principle of the above-described prior art.

### Means for Solving the Problems

A liquid atomizing device of the present invention includes;
a first gas injection portion and a second gas injection portion for making two gas flows collide against each other;
a liquid outflow portion from which liquid flows out;
a gas-liquid mixing area portion where a gas flow injected from the first gas injection portion, a gas flow injected from the second gas injection portion and liquid which flows out from the liquid outflow portion are made to collide against each other to atomize the liquid;
an injection outlet portion in which the gas-liquid mixing area portion is formed; and
a slit portion formed in a tip end surface of the injection outlet portion along a direction in which a mist atomized the liquid is injected widely.

A working-effect of this configuration will be described with reference to FIG. 1 (schematic sectional view of atomizing area portion). Gas flows 11 and 21 injected from first and second gas injection portions 1 and 2 are made to collide against each other to form a collision portion 100. A portion including this collision portion 100 is defined as a collision wall 101 (FIG. 1(a)). Liquid 61 flowing out from a liquid outflow portion 6 collides against the collision portion 100 or the collision wall 101 (FIG. 1(b)). If the liquid 61 collides against the collision portion 100 or the collision wall 101, the liquid 61 is crushed (atomized) and becomes mist 62. An area where mist 62 is generated is shown by broken lines as a gas-liquid mixing area portion 120. An atomizing direction of mist 62 is controlled by an injection outlet portion 3 which surrounds the mist 62. In FIG. 1, the injection outlet 3 is formed along an atomizing direction axis of the mist 62. As shown in FIGS. 1(c) and (d), a slit portion 31 is formed in a tip end surface of the injection outlet portion 3 along a direction in which mist 62 is widely atomized. It is preferable that the slit portion 31 is formed in a direction perpendicularly intersecting with gas injection direction axes of the first and second gas injection portions 1 and 2 when a liquid atomizing device is viewed from front toward the injection outlet portion 3.

According to the above configuration, a liquid flow flowing out from the liquid outflow portion is made to collide against the collision portion or the collision wall formed by gas flows injected from the two gas injection portions, thereby producing mist. Since the slit portion is provided in the tip end of the injection outlet portion (from an outlet of the gas-liquid mixing area 120 or a position of the collision portion to a tip end surface of the injection outlet portion), it is possible to generate more miniaturized mist. The injection outlet portion may integrally be formed on a member which forms a gas orifice or may independently be formed from that member.

According to the liquid atomizing device of the invention, liquid flow and the collision portion or the collision wall of the gas flows are made to collide with each other and pulverized. According to this collision, it is possible to efficiently atomize under a low pressure (low gas pressure, low liquid pressure) at low flow rate (low gas flow rate, low liquid flow rate) with low energy and efficiently. As compared with the conventional two-fluid nozzle, it is possible to atomize with low gas-liquid volume ratio (or gas-liquid ratio) . As compared with the conventional two-fluid nozzle, the liquid atomizing device of the invention has lower noise. A structure of the liquid atomizing device of the invention can be simplified.

Although a pressure and a flow rate of gas (gas flow) injected from the gas injection portion are not especially limited, it is possible to suitably atomize liquid under a low gas pressure at a low gas flow rate by the atomizing principle of the invention. It is preferable that pressures of gases which configure the collision portion and the collision wall are set equal to or substantially equal to each other, and it is preferable that flow rates of gases (gas-flows) configuring the collision portion and the collision wall are set equal to or substantially equal to each other. A cross sectional shape of gas-flow injected from the gas injection portion is not especially limited, and it is possible to employ a circular shape, an oval shape, a rectangular shape and a polygonal shape. It is preferable that cross sectional shapes of gases (gas-flows) which configure the collision portion and the collision wall are equal to or substantially equal to each other. It is preferable that a collision portion having a constant shape and a constant size is maintained by suppressing deformation and size reduction of the collision portion, so that an atomized body having a stable atomizing amount and small change in particle diameter is produced.

Although a pressure and a flow rate of liquid (liquid-flow) flowed out from the liquid outflow portion are not especially limited, it is possible to suitably atomize liquid having a low pressure and a low flow rate by the atomizing principle of the invention. A pressure of the liquid injection portion may be a water pressure in a general water pipe, and the liquid outflow portion may be a device which makes liquid drop naturally. In this invention, concerning an expression “liquid flowed out by the liquid outflow portion”, liquid which drops at a natural dropping speed is included in the “flowed-out liquid”.

When flowed-out liquid and the collision portion or the collision wall of the gases (gas-flows) are made to collide with each other, it is preferable that a collision cross-sectional area of liquid is smaller than the collision portion or the collision wall. If an injection cross section of flowed-out liquid is greater than the collision portion or the collision wall of gases (gas-flows), a portion of liquid does not collide with the collision portion or the collision wall and is not atomized and this is not preferable. When it is desired to atomize a portion of liquid as one example of an embodiment, an injection cross section of liquid may be set greater than the collision portion or the collision wall of gases (gas-flows), or a relative disposition of the liquid outflow portion and the gas injection portion may be set such that a portion of flowed-out liquid collides with the collision portion or the collision wall.

It is preferable that an orifice diameter of the gas injection portion (diameter d1 of circular cross section) is 1 to 1.5 times of an orifice diameter of the liquid outflow portion (diameter d3 of circular cross section). When cross sections of the first and second gas injection portions are rectangular in shape, it is preferable that a width (d1) of the first gas injection portion and a width (d2) of the second gas injection portion on a side of a surface which collides against a fluid flow are 1 to 1.5 times of an outlet orifice diameter (d3) of the liquid outflow portion. According to this configuration, uniform particle diameters and a uniform dispersion distribution can be obtained. If the width d1 of the gas injection portion is excessively larger than the outlet orifice diameter d3 of the liquid outflow portion, miniaturization of a central portion of an atomizing pattern is deteriorated, and rough particles are prone to be generated. If the width d1 of the gas injection portion is excessively smaller than the outlet orifice diameter d3 of the liquid outflow portion, rough particles are prone to be often generated on both sides of the atomizing pattern in a long-diameter direction.

Relative arrangement examples of the liquid outflow portion and the gas injection portion will be described with reference to FIGS. 3A to 3F. By the relative arrangements, a gas-liquid collision position is determined. According to the arrangement shown in FIG. 3A, the first and second gas injection portions 1 and 2 are opposed to each other, and a nozzle tip end of the liquid outflow portion 6 is in contact with outer side surfaces of both nozzle tip ends of the first and second gas injection portions 1 and 2. According to the arrangement shown in FIG. 3B, the first and second gas injection portions 1 and 2 are opposed to each other, and both the nozzle tip ends of the first and second gas injection portions 1 and 2 and the nozzle tip end of the liquid outflow portion 6 are in contact with each other. In the arrangement of FIG. 3B, there is a tendency that a flow rate of liquid which flows out is greater and backflow is smaller than that of the arrangement of FIG. 3A. According to the arrangement shown in FIG. 3C, a nozzle of the liquid outflow portion 6 enters between both the nozzle tip ends of the first and second gas injection portions 1 and 2. According to the arrangement shown in FIG. 3D, a distance between both the nozzles of the first and second gas injection portions 1 and 2 is greater than that of FIG. 3B. According to the arrangement shown in FIG. 3E, the liquid outflow portion 6 is far from the collision wall as compared with FIG. 3B. Although the number of liquid outflow portion is one, the number thereof may be two or more, and two liquid outflow portions are disposed in FIG. 3F. The injection outlet 3 is omitted in FIGS. 2 and 3.

The produced mist is injected together with discharged gas flow which is discharged out from collision portions of gas flows. An atomizing pattern is formed by the discharged gas flow. When liquid and the collision portion formed by collision of the two injected gas flows collide against each other, the atomizing pattern is formed into a wide fan shape formed around a liquid outflow direction axis, and its cross sectional shape is an oval shape or a long circular shape (see FIGS. 2A and 2B). In FIG. 2A, there is a tendency that mist 62 spreads into a fan shape in a direction perpendicularly intersecting with gas injection direction axes of the first and second gas injection portions 1 and 2. Collided gas (after collision) diffuses in parallel to a collision surface at which the gas flows collide against each other (in a direction in which the collision surface spreads) , and the mist 62 is injected in this direction widely in the fan shape. In the present invention, a wide-angle injection angle γ is 100° to 150°.

As one embodiment of the invention, it is preferable that an intersection angle between an injection direction axis of the first gas injection portion and an injection direction axis of the second gas injection portion is in a range of 90° to 180°.

An angle range where injection direction axes of the first and second gas injection portions 1 and 2 intersect corresponds to a collision angle of gas injected from the first gas injection portion 1 and gas injected from the second gas injection portion 2. For example, the “collision angle α” is 90° to 220°, preferably 90° to 180°, and more preferably 110° to 180°. FIG. 4 shows a collision angle α. When liquid is flowed out to a collision portion which forms a collision angle smaller than 180°, as the collision angle is smaller, it resembles a conventional two-fluid nozzle principle (gas and liquid are flowed out in the same injection direction and liquid is miniaturized by a shear effect generated by accompanying flow of gas and liquid). Therefore, there is a tendency that the effect of the miniaturization principle of the invention becomes low, but as the collision angle is smaller, there is a tendency that backflow of injected liquid is suppressed. When liquid is flowed out to a collision portion which forms a collision angle greater than 180°, as the collision angle is greater, there is a tendency that injected gas and gas which collides and widens function to push back flowed-out liquid to make the liquid flow backward. In FIG. 4, a tip end of the nozzle of the liquid outflow portion 6 is in contact with tip ends of both the nozzles of the gas injection portions 1, 2, but the invention is not limited to this configuration. A position of the tip end of the nozzle of the liquid outflow portion 6 may be disposed between both the nozzles of the gas injection portions 1, 2 or may be separated away from the gas injection portions 1, 2 as compared with the disposition shown in FIG. 4.

As one embodiment of the invention, it is that an injection direction of the first gas injection portion and an injection direction of the second gas injection portion are opposed to each other (are opposite from each other), and an injection direction axis of the first gas injection portion and an injection direction axis of the second gas injection portion match with each other. This means that a collision angle a of gas injected from the first gas injection portion and gas injected from the second gas injection portion is 180°, and the injection direction axes match with each other.

As one embodiment of the invention, it is preferable that the liquid outflow portion flow out liquid such that the outflow direction axis of liquid intersects with the collision portion at right angles. FIG. 1(b) shows an example in which the outflow direction axis of liquid intersects with the collision portion 100 and the collision wall 101 at right angles. As another embodiment, FIG. 5 shows an example in which the outflow direction axis of liquid is inclined with respect to a collision face 100a of the collision portion 100. This inclination angle β is in a range of ±80° from 0° (intersection position), preferably in a range of ±45° from 0°, more preferably in a range of 30° from 0°, and more preferably in a range of ±15° from 0°. As the inclination angle β becomes smaller, there is a tendency that producing efficiency of mist is higher.

As one embodiment of the invention, it is preferable that an opening portion which inclines with respect to the liquid outflow direction axis through 90° or more is formed in the injection outlet portion along a direction in which the mist is injected widely. As shown in FIG. 1(e), the opening portion 32 is provided in a direction in which injected mist 62 spreads in a fan shape, it is possible to release mist 62 toward the opening portion 32, and to moderate a degree of collision against a wall surface of the injection outlet 3. It is possible to effectively suppress a drop or dew generated by collision between mist 62 and the wall surface. It is preferable to form the opening portion 32 from a location in the vicinity of an outlet of the liquid orifice because collision between mist 62 and the wall surface can further be reduced. It is preferable to set a width of the opening portion 32 in accordance with a cross section width (shorter width) of generated mist 62 (it is preferable to set the width of the opening portion 32 equal to or greater than the cross section width of the mist 62).

As one embodiment of the invention, it is preferable that the slit portion is formed in the opening portion.

As one embodiment of the invention, it is preferable that the liquid flow is of continuous flow, intermittent flow or impulse flow. The continuous flow is columnar liquid flow.

The intermittent flow is liquid flow injecting at predetermined intervals. The impulse flow is liquid flow injecting instantaneously at predetermined timing. By controlling an injection method of liquid at will by a liquid supply device or the like, it is possible to control atomizing timing and an atomizing amount of mist at will.

As one embodiment of the invention, the liquid is miniaturized liquid. As liquid injected from the liquid injection portion, it is possible to use miniaturized liquid minute particle, and an example of the liquid minute particle is liquid minute particle which is miniaturized by a two-fluid nozzle device, an ultrasound device, an extra-high voltage atomizer, a steaming type atomizer and the like.

The gas is not especially limited, but examples of the gas are air, clean air, nitrogen, inert gas, fuel mixture air and oxygen, and it is possible to appropriately set gas in accordance with intended use.

The liquid is not especially limited, but examples of the liquid are water, ionized water, cosmetic medicinal solution such as skin lotion, medicinal solution, bactericidal solution, medicinal solution such as sterilization solution, paint, fuel oil, coating agent, solvent and resin.

### BRIEF DESCRIPTION OF THE DRAWINGS

FIGS. 1 are schematic diagrams for explaining one example of a liquid atomizing device.

FIG. 2A is a schematic diagram of an injection outlet portion of the liquid atomizing device as viewed from above.

FIG. 2B is a schematic diagram of the liquid atomizing device as viewed from its side.

FIG. 3A is a schematic diagram of a relative arrangement example between a liquid outflow portion and a gas injection portion.

FIG. 3B is a schematic diagram of a relative arrangement example between a liquid outflow portion and a gas injection portion.

FIG. 3C is a schematic diagram of a relative arrangement example between a liquid outflow portion and a gas injection portion.

FIG. 3D is a schematic diagram of a relative arrangement example between a liquid outflow portion and a gas injection portion.

FIG. 3E is a schematic diagram of a relative arrangement example between a liquid outflow portion and a gas injection portion.

FIG. 3F is a schematic diagram of a relative arrangement example between a liquid outflow portion and a gas injection portion.

FIG. 4 is a schematic diagram for explaining an intersection angle formed by two gas injection axes.

FIG. 5 is a schematic diagram for explaining an inclination in a liquid outflow direction.

FIG. 6A(a) is a partial side sectional view and FIG. 6A(b) is a front view of the liquid atomizing device of a first embodiment.

FIG. 6B is an enlarged view of details of a portion A in FIG. 6A.

FIG. 6C is a sectional view taken along a line B-B in FIG. 6B.

FIG. 7A(a) is a partial side sectional view and FIG. 7A(b) is a front view of a liquid atomizing device of a second embodiment.

FIG. 7B is an enlarged view of details of a portion A in FIG. 7A.

FIG. 7C is a sectional view taken along a line B-B in FIG. 7B.

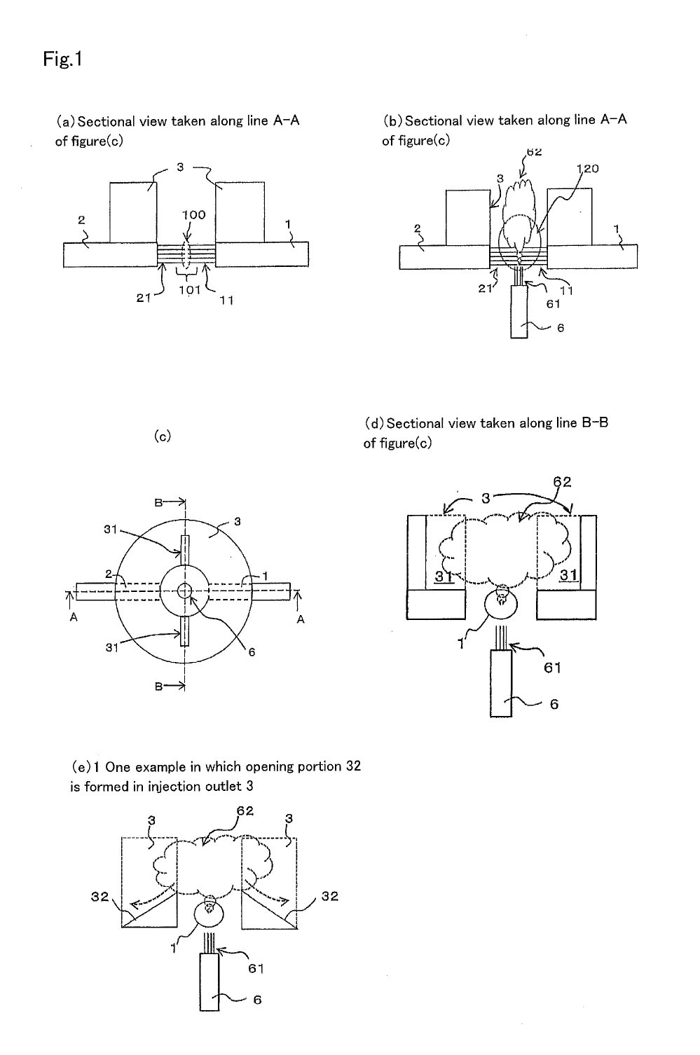

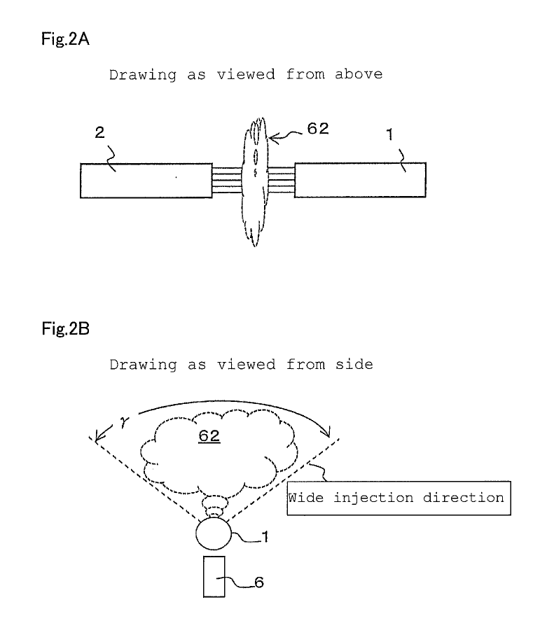

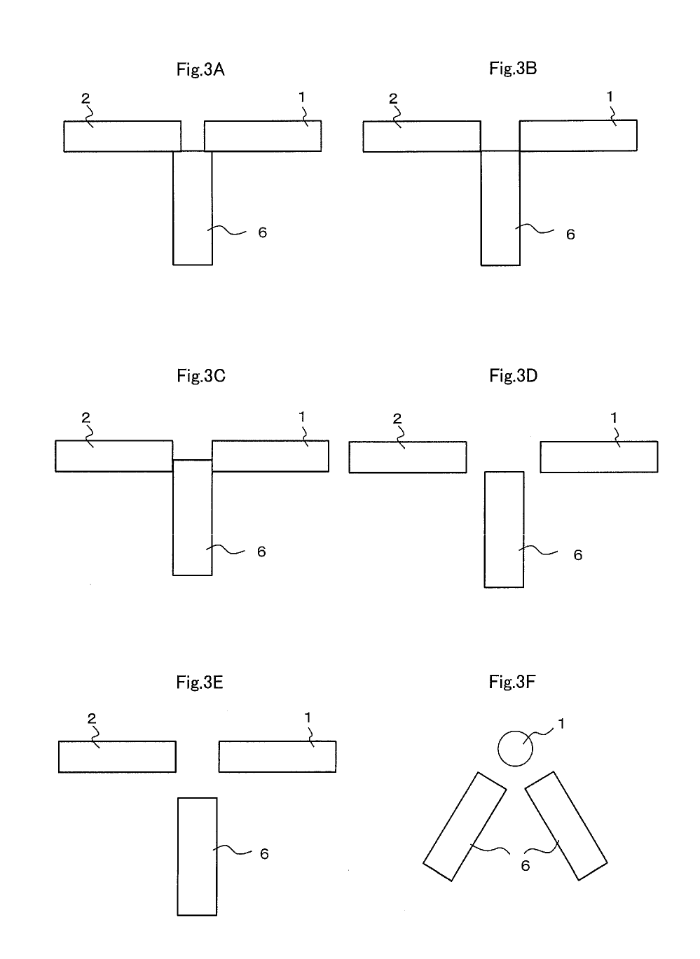

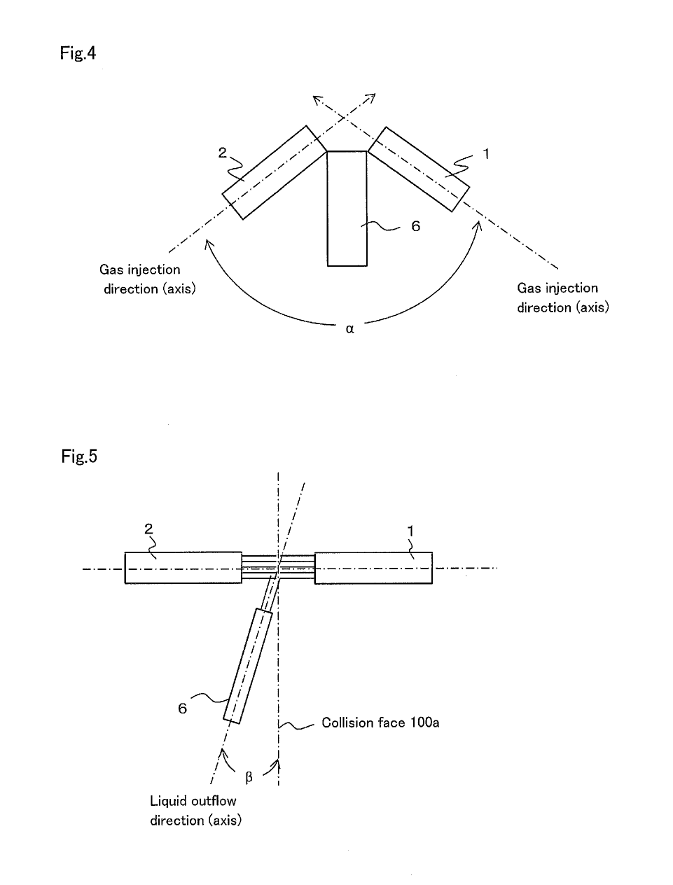

### MODE FOR CARRYING OUT THE INVENTION

(First Embodiment)

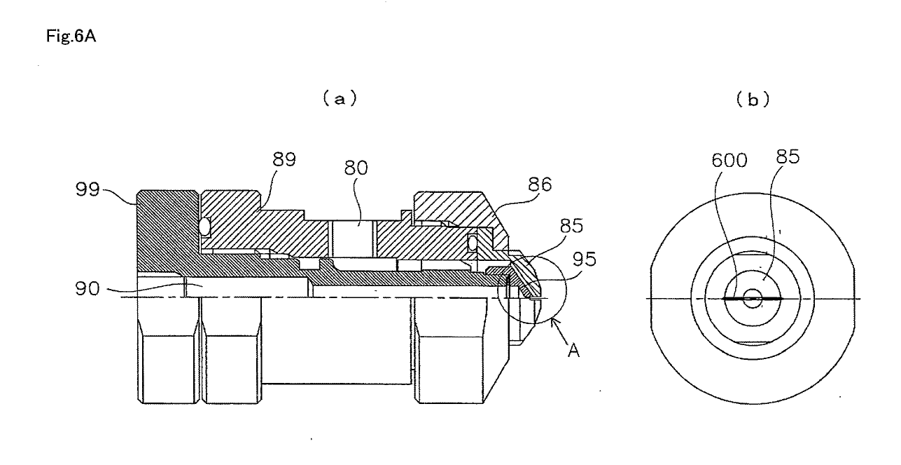

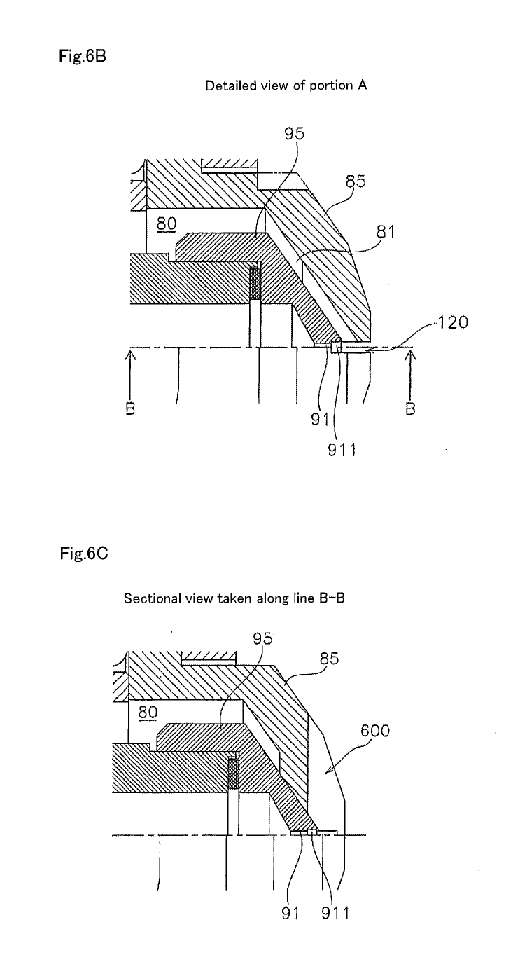

A liquid atomizing device of a first embodiment will be described with reference to FIGS. 6A to 6C. The liquid atomizing device shown in FIGS. 6A to 6C is configured as a nozzle device. A first gas orifice 81 configuring a first gas injection portion and a second gas orifice (not shown) configuring a second gas injection portion are disposed such that gas flows collide against each other at a collision angle) (α=110°). Orifice cross sections thereof are quadrangular in shape.

Gas is supplied from a gas passage portion 80. If the gas passage portion 80 is connected to a compressor (not shown) and the compressor is controlled, an injection amount and an injection speed of gas can be set. The gas passage portion 80 is in communication with both the first gas orifice 81 and the second gas orifice, and the injection amounts and the injection speeds (flow speed) of gases respectively injected from the first gas orifice 81 and the second gas orifice are set the same (or approximately same).

Liquid is supplied from a liquid passage portion 90. The liquid passage portion 90 is connected to a liquid supply portion (not shown), and the liquid supply portion pressurizes liquid and sends the liquid to the liquid passage portion 90. The liquid supply portion sets a liquid sending amount and a liquid sending speed of liquid. The liquid passage portion 90 is formed in a nozzle-interior body 99. The gas passage portion 80 is formed by a nozzle-exterior body 89 which is assembled in and fixed to an outer wall of the nozzle-interior body 99 through a screw.

An inner cap portion 95 is assembled into a tip end of the nozzle-interior body 99, and a liquid orifice 91 for injecting liquid supplied from the liquid passage portion 90 is formed by the inner cap portion 95. It is preferable that a cross sectional shape of the liquid orifice 91 is circle. In this embodiment, the liquid orifice 91 straightly extends in its axial direction, and a large-diameter portion 911 having an orifice diameter of its tip end which is greater than orifice diameters of other portions is formed. The straight liquid orifice 91 is provided with the large-diameter portion 911, thereby producing a negative pressure in a space opposite from a mist atomizing direction to miniaturize liquid.

An outer cap portion 85 is assembled into a tip end of the nozzle-exterior body 89. A screwing portion 86 is screwed into and fixed to the nozzle-exterior body 89, thereby respectively fixing the outer cap portion 85 which comes into direct contact with the screwing portion 86 and the inner cap portion 95 which is pressed by the outer cap portion 85. The first gas orifice 81 and the second gas orifice (not shown) form a groove with a rectangular cross section in an outer wall surface of the inner cap portion 95. The outer cap portion 85 as a lid is put on the groove, thereby forming the first gas orifice 81 and the second gas orifice (not shown) having rectangular cross sections. The connecting means is not limited to the screwing and fixing means, and other means can be used. Seal members not shown (e.g., O-rings) may appropriately be assembled into gaps between various members.

As shown in FIG. 6B, gas flows injected from the first gas orifice 81 and the second gas orifice form a collision wall (including collision portion) in the gas-liquid mixing area portion 120. Liquid injected from the liquid orifice 91 is made to collide against this collision wall, thereby atomizing the liquid.

A straight slit portion 600 is formed in a tip end of the outer cap portion 85. A diameter of the liquid orifice 91 of the tip end of the inner cap portion 95 is made large in accordance with a shape of the slit portion 600. FIG. 6B is a detailed diagram (enlarged view) of a portion A and FIG. 6C is a sectional view taken along a line B-B. As shown in these drawings, the slit portion 600 is formed in the outer cap portion 85, and is formed along a wide atomizing direction axis of mist (long diameter direction of spray pattern).

The tip end of the inner cap portion 95 projects into a recess groove of the slit portion 600. Since the inner cap portion 95 (tip end of liquid orifice 91) projects into the recess groove of the slit portion 600, a recess groove which is receded inward of the collision portion formed by gas flows is formed, the atomizing direction of mist can be guided in the direction of the slit portion 600, and it is possible to suppress generation of a drop or dew.

Lengths of the slit portion 600 in its long direction and short direction and a depth of the recess groove can be set in accordance with miniaturization precision. Assuming that a cross sectional shape of the liquid orifice is circle, if a diameter of the liquid orifice is 1, the length of the slit portion 600 in the long direction can be set in a range of 5 to 300, the length thereof in the short direction can be set in a range of 1 to 20, and the depth of the recess groove can be set in a range of 10 to 100. By this slit portion 600, it is possible to generate mist which is miniaturized as compared with a case where there is no slit portion.

As another embodiment, the number of the slit portion 600 is not limited to one, a plurality of slits intersecting with each other may be formed, and the slit is not limited to the straight shape and the slit may be curved. The slit portion 600 may be formed in the outer cap portion 85 in a form of a recess groove, and the slit portions 600 may be formed in the outer cap portion 85 and the inner cap portion 95. A cross sectional shape of the recess groove of the slit portion 600 is not limited to the rectangular shape, and it is possible to employ a trapezoid shape which spreads toward its tip end in the atomizing direction of mist, a semi-circular shape and a semi-oval shape.

Although the outer cap portion 85 and the inner cap portion 95 form the first and second gas orifices in the first embodiment, one member may form the first and second gas orifices. The cross sectional shapes of the first and second gas orifices are not limited to the rectangular shapes, and the cross sectional shapes may be other polygonal shapes or circular shapes. The gas-liquid mixing area portion 120 may be of cylindrical shape, conical shape or pyramid shape. A collision angle a of gas flows is not limited to 110°, and the collision angle can freely be set in a range of 90° to 180° for example.

(Second Embodiment)

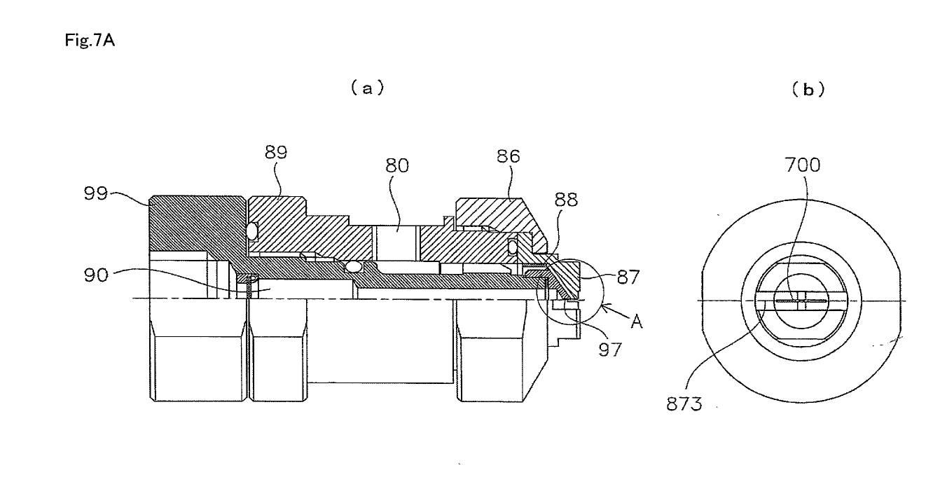

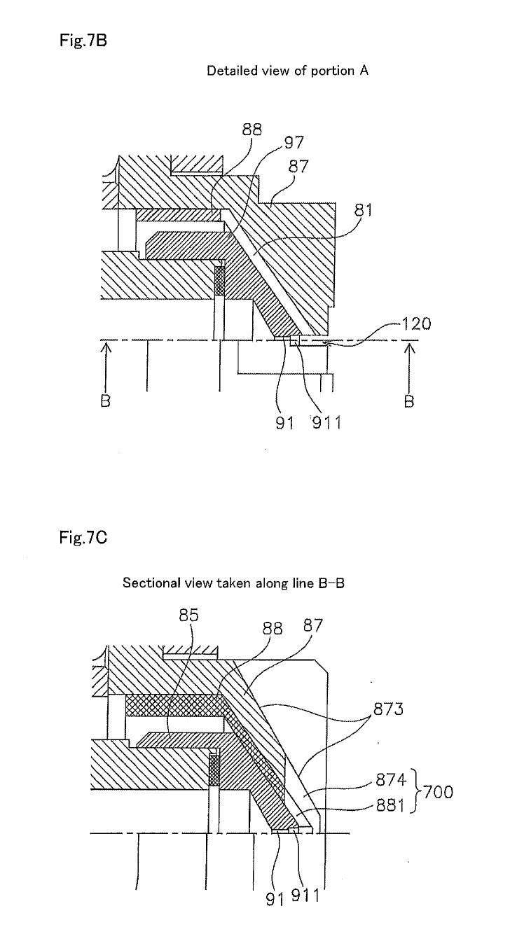

A liquid atomizing device (configured as a nozzle device) according to a second embodiment has an injection outlet portion in which an opening portion is formed, and this point is different from the first embodiment. The second embodiment will be described with reference to FIGS. 7A to 7C. A first gas orifice 81 configuring a first gas injection portion and a second gas orifice (not shown) configuring a second gas injection portion are disposed such that gas flows collide against each other at a collision angle (α=110°). Orifice cross sections thereof are quadrangular in shape. A gas passage portion 80 and a liquid passage portion 90 are similar to those of the first embodiment, and a liquid supply portion and a compressor which supplies gas can employ the similar configurations.

An inner cap portion 95 is assembled into a tip end of a nozzle-interior body 99, and the inner cap portion 95 forms a liquid orifice 91 which injects liquid supplied from the liquid passage portion 90. It is preferable that a cross sectional shape of the liquid orifice 91 is circle. In this embodiment, the liquid orifice 91 straightly extends in its axial direction, and a large-diameter portion 911 having an orifice diameter of its tip end which is greater than orifice diameters of other portions is formed. The straight liquid orifice 91 is provided with the large-diameter portion 911, thereby producing a negative pressure in a space opposite from a mist atomizing direction to miniaturize liquid.

A first outer cap portion 87 is assembled into a tip end of a nozzle-exterior body 89. A screwing portion 86 is screwed into and fixed to the nozzle-exterior body 89, thereby respectively fixing the first outer cap portion 87 which comes into direct contact with the screwing portion 86 and the inner cap portion 95 which is pressed by the first outer cap portion 87 through the second outer cap portion 88. Two penetrating slits (not shown) are formed in the second outer cap portion 88, the second cap portion 88 abuts against an outer wall surface of the inner cap portion 95, and the first outer cap portion 87 abuts against the second cap portion 88. Thereby, a space of the penetrating slits forms the first gas orifice 81 and the second gas orifice (not shown). The connecting means is not limited to the screwing and fixing means, and other means can be used. Seal members (e.g., O-rings) may appropriately be assembled into gaps between various members.

As shown in FIG. 7B which is a detailed diagram (enlarged view) of a portion A, gas flows injected from the first gas orifice 81 and the second gas orifice form a collision wall (including collision portion) in the gas-liquid mixing area portion 120. Liquid injected from the liquid orifice 91 is made to collide against this collision wall, thereby atomizing the liquid.

Opening portions 873 are formed in both sides of the first outer cap portion 87. The opening portions 873 incline with respect to a liquid orifice axis through 120°. A slit portion 700 is formed in parallel to the opening portions 873. As shown in FIGS. 7B and 7C, the slit portion 700 is formed along a direction in which mist is widely injected. The slit portion 700 is composed of a recess groove 874 formed in a tip end of the first outer cap portion 87 and a penetrating slit 881 of the second outer cap portion 88. Although the opening portions 873 are formed on the two opposite sides of the liquid orifice axis in FIG. 7, the opening portions 873 may be formed only on one side, and the opening portions 873 may incline with respect to the liquid orifice axis through another angle (90° or greater) other than 120°.

The tip end of the inner cap portion 95 projects into the recess groove of the slit portion 700. Since the inner cap portion 95 (tip end of liquid orifice 91) projects into the recess groove of the slit portion 700, a recess groove which is receded inward of the collision portion formed by gas flows is formed, the atomizing direction of mist can be guided in the direction of the slit portion 700 of an inclined surface, and it is possible to suppress generation of a drop or dew.

Lengths of the slit portion 700 in its long direction and short direction and a depth of the recess groove can be set in accordance with miniaturization precision. Assuming that a cross sectional shape of the liquid orifice is circle, if a diameter of the liquid orifice is 1, the length of the slit portion in the long direction can be set in a range of 5 to 300, the length thereof in the short direction can be set in a range of 1 to 20, and the depth of the recess groove can be set in a range of 10 to 100. By this slit portion 700, it is possible to generate mist which is miniaturized as compared with a case where there is no slit portion.

As another embodiment, the number of the slit portion 700 is not limited to one, a plurality of slits intersecting with each other may be formed, and the slit is not limited to the straight shape and the slit may be curved. The slit portion 700 maybe formed by the first outer cap portion 87 and the second outer cap portion 88, or may be formed by the inner cap portion 95. A cross sectional shape of the recess groove of the slit portion 700 is not limited to the rectangular shape, and it is possible to employ a trapezoid shape which spreads toward its tip end in the atomizing direction of mist, a semi-circular shape and a semi-oval shape.

Although the inner cap portion 95, the first outer cap portion 87 and the second outer cap portion 88 form the first and second gas orifices in the second embodiment, one member may form the first and second gas orifices, or the inner cap portion 95 and the first outer cap portion 87 may form the first and second gas orifices (second outer cap portion may be omitted). The cross sectional shapes of the first and second gas orifices are not limited to the rectangular shapes, and the cross sectional shapes maybe other polygonal shapes or circular shapes. The gas-liquid mixing area portion 120 may be of cylindrical shape, conical shape or pyramid shape. A collision angle a of gas flows is not limited to 110°, and the collision angle can freely be set in a range of 90° to 180° for example.

(Evaluation of atomizing characteristics)

Atomizing characteristics were evaluated using the liquid atomizing devices of the configurations shown in the first and second embodiments. An example 1 has the configuration of the first embodiment. The slit portion 600 of the example 1 had a length in the long direction of 10 mm, a length in the short direction of 1.0 mm, and a recess groove depth of 0.6 mm. A diameter of a cross section of the liquid orifice 91 was φ0.25 mm, and a large-diameter portion 911 was φ0.3 mm. Rectangular cross sections of the first and second gas orifices had widths of 0.4 mm×depths of 0.15 mm. An example 2 has the configuration of the second embodiment. The slit portion 700 of the example 2 had a length in the long direction of 10 mm, a length in the short direction of 2 mm, and a recess groove depth of 1.1 mm. A diameter of a cross section of the liquid orifice 91 was φ0.25 mm, and a large-diameter portion 911 was φ0.1 mm. Rectangular cross sections of the first and second gas orifices had widths of 0.4 mm×depths of 0.15 mm. Air was used as gas, and water was used as liquid. When an air amount Qa of gas injection was defined as 8.0 (NL/min) and an atomizing (water) amount Qw was defined as 50.0 (ml/min) (gas-water ratio was 160.0), an air pressure Pa, a water pressure Pw and an average particle diameter (SMD) were evaluated. As a comparative example, an air amount and an atomizing (water) amount having an average particle diameter which was close to that of the example 1 were evaluated in a conventional inner mixed type two-fluid nozzle. A liquid orifice diameter φ of the two-fluid nozzle is 2.5 mm. A result of the evaluation is shown in Table 1. The average particle diameter (SMD) was measured by a measuring device of a laser diffractometry. Measuring positions of the examples 1 and 2 were on the atomizing direction axis and at a position of 150 mm from a nozzle tip end. A measuring position of the comparative example was on the atomizing direction axis and at a position of 300 mm from a nozzle tip end.

TABLE 1

| | | | Air | Injection | Gas- | Average |
|---|---|---|---|---|---|---|
| | Air | Water | amount | amount | water | particle |
| | pressure | pressure | Qa | Qw | ratio | diameter |
| | Pa (Mpa) | Pw (Mpa) | (NL/min) | (ml/min) | (Qa/Qw) | SMD (μm) |
| Example 1 | 0.337 | 0.250 | 8.00 | 50.00 | 160.0 | 14.61 |
| (FIG. 6 of first | | | | | | |
| embodiment) | | | | | | |
| Example 2 | 0.640 | 0.320 | 8.00 | 50.00 | 160.0 | 6.79 |
| (FIG. 7 of second | | | | | | |
| embodiment) | | | | | | |
| Conventional | 0.400 | 0.008 | 54.00 | 35.00 | 1542.9 | 14.80 |
| two-fluid nozzle | | | | | | |

As shown in the evaluation result shown in Table 1, in the examples 1 and 2, the average particle diameter (SMD) was made small even under a substantially small gas-water ratio in comparison with the comparative example. In the example 2, mist of an average particle diameter of equal to or less than half of the example 1 could be obtained. In the example 2, since the opening portion was provided, generation of a drop or dew at the nozzle tip end could be suppressed.

### DESCRIPTION OF REFERENCE SIGNS

1 first gas injection portion (first gas orifice)

2 second gas injection portion (second gas orifice)

6 liquid outflow portion (liquid orifice)

32, 873 opening portion

62 mist

81 first gas orifice

91 liquid orifice

100 collision portion

101 collision wall

120 gas-liquid mixing area

600, 700 slit portion

1. A liquid atomizing device, comprising:
a first gas injection portion and a second gas injection portion for making two gas flows collide against each other;
a liquid outflow portion from which liquid flows out;
a gas-liquid mixing area portion where a gas flow injected from the first gas injection portion, a gas flow injected from the second gas injection portion and liquid which flows out from the liquid outflow portion are made to collide against each other to atomize the liquid;
an injection outlet portion in which the gas-liquid mixing area portion is formed; and
a slit portion formed in a tip end surface of the injection outlet portion along a direction in which a mist atomized the liquid is injected widely.

2. The liquid atomizing device according to claim 1, wherein an intersection angle between an injection direction axis of the first gas injection portion and an injection direction axis of the second gas injection portion is in a range of 90° to 180°.

3. The liquid atomizing device according to claim 1, wherein an opening portion which inclines with respect to a liquid outflow direction axis through 90° or more is formed in the injection outlet portion along a direction in which the mist is injected widely.

4. The liquid atomizing device according to claim 3, wherein the slit portion is formed in the opening portion.

5. The liquid atomizing device according to claim 1, wherein the slit portion is formed in a direction in which the slit portion intersects with gas injection direction axes of the first gas injection portion and the second gas injection portion at right angles when the liquid atomizing device is viewed from front toward the injection outlet portion.
